(19) United States
(12) Patent Application Publication
(10) Pub. No.: US 2026/0076419 A1
(43) Pub. Date: Mar. 19, 2026

(54) IMPEDANCE IDENTIFICATION METHOD FOR ULTRASONIC ATOMIZER, AND ULTRASONIC ATOMIZER

(71) Applicant: SHENZHEN FIRST UNION TECHNOLOGY CO., LTD., Shenzhen, Guangdong Province (CN)

(72) Inventors: Xinjun LI, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 19/102,400

(22) PCT Filed: Aug. 14, 2023
(86) PCT No.: PCT/CN2023/112888

§ 371 Date: Feb. 9, 2025

(30) Foreign Application Priority Data
Aug. 15, 2022 (CN) 202210976844.4
Aug. 15, 2022 (CN) 202210976858.6

(51) Int. Cl. A24F 40/53; A24F 40/05; A24F 40/10; A24F 40/42; B05B 17/06

(52) U.S. Cl. CPC A24F 40/53; A24F 40/05; A24F 40/10; A24F 40/42; B05B 17/0669

(57) ABSTRACT

An impedance identification method for an ultrasonic atomizer (100), and an ultrasonic atomizer (100). The impedance identification method is used for identifying the impedance of an ultrasonic atomization sheet (12) in an ultrasonic atomizer (100). The method comprises: acquiring a first current, wherein the first current is a current which is output from a power source (14) in an ultrasonic atomizer (100) when an ultrasonic atomization sheet (12) operates at a resonant frequency; and according to preset correspondences between currents and impedance intervals, determining an impedance interval corresponding to the first current.

### CROSS-REFERENCE TO RELATED APPLICATIONS

This application claims priority to Chinese Patent Application No. 202210976858.6, filed with the China National Intellectual Property Administration on Aug. 15, 2022 and entitled “IMPEDANCE IDENTIFICATION METHOD FOR ULTRASONIC ATOMIZER, AND ULTRASONIC ATOMIZER”, which is incorporated herein by reference in its entirety, and claims priority to Chinese Patent Application No. 202210976844.4, filed with the China National Intellectual Property Administration on Aug. 15, 2022 and entitled “ULTRASONIC ATOMIZER”, which is incorporated herein by reference in its entirety.

### TECHNICAL FIELD

This application relates to the field of ultrasonic atomization technologies, and in particular, to an impedance identification method for an ultrasonic atomizer, and an ultrasonic atomizer.

### BACKGROUND

An ultrasonic atomizer refers to a device that uses ultrasonic atomization technologies to implement an atomization function. At present, during use of ultrasonic atomizers, there is a problem that the ultrasonic atomizers have significant difference in atomization performance due to electrical characteristics of different ultrasonic atomization sheets. The main reasons are as follows. On one hand, the ultrasonic atomization sheets are made of piezoelectric materials, and the piezoelectric materials have significant difference in electrical characteristics, resulting in difference in electrical characteristics of different ultrasonic atomization sheets. On the other hand, after the ultrasonic atomization sheets are assembled, differences in assembly structure stress, pressure on the ultrasonic atomization sheets, contact resistance, and the like may also result in difference in the electrical characteristics of the ultrasonic atomization sheets.

At present, the above problems are usually solved by a method of identifying an impedance of an ultrasonic atomization sheet, and the method is specifically implemented in combination with a direct digital frequency synthesis (DDS) algorithm, a phase detection circuit, and an amplitude detection circuit. To be specific, amplitudes and phases of the ultrasonic atomization sheet and a load are collected, and then the collected data is sent to a processor, such that the impedance of the ultrasonic atomization sheet is determined through the processor.

However, the above method is high in cost, requires complicated circuits, is difficult to implement, and therefore is poor in practicability.

### SUMMARY

Embodiments of this application aim to provide an impedance identification method for an ultrasonic atomizer, and an ultrasonic atomizer, which can realize identification of an impedance of an ultrasonic atomization sheet by using a simpler method, reduce costs, and achieve high practicality.

To achieve the above objective, according to a first aspect, this application provides an impedance identification method for an ultrasonic atomizer, where the method is used for identifying an impedance of an ultrasonic atomization sheet in an ultrasonic atomizer and includes: acquiring a first current, where the first current is a current output from a power supply in the ultrasonic atomizer when the ultrasonic atomization sheet operates at a resonance frequency; and determining, according to a correspondence between a preset current and a preset impedance interval, an impedance interval corresponding to the first current.

In an embodiment, the determining a first impedance branch matching the impedance of the ultrasonic atomization sheet in the ultrasonic atomizer includes: acquiring a first current, where the first current is a current output from a power supply in the ultrasonic atomizer when the ultrasonic atomization sheet operates at a resonance frequency; and determining, according to the first current and a correspondence between a preset current and a preset impedance interval, an impedance interval corresponding to the first current; and determining an impedance branch matching the impedance interval according to the impedance interval, to determine a first impedance branch matching the impedance of the ultrasonic atomization sheet in the ultrasonic atomizer.

In an embodiment, the correspondence between the preset current and the preset impedance interval includes a correspondence between a preset current interval and a preset impedance interval; and the determining, according to the first current and a correspondence between a preset current and a preset impedance interval, an impedance interval corresponding to the first current includes: determining a current interval within which the first current falls; and determining the impedance interval corresponding to the first current interval according to a correspondence between a preset current interval and a preset impedance interval.

In an embodiment, a plurality of preset current intervals are provided, and a plurality of preset impedance intervals are provided, where at least one preset impedance interval is within [5 Ω-50 Ω], and at least one preset current interval is within [0.5 A-2.2 A].

In an embodiment, before the acquiring a first current, the method further includes: controlling the power supply to output an initial voltage to start the ultrasonic atomization sheet to operate, where the initial voltage is any value within [5 V, 6 V].

In an embodiment, the acquiring a first current includes: outputting a plurality of driving frequencies; collecting, at at least some of the plurality of driving frequencies, an output current of the power supply at each driving frequency; determining a maximum current among the output currents; and determining the first current according to the maximum current.

In an embodiment, the collecting, at at least some of the plurality driving frequencies, an output current of the power supply at each driving frequency includes: collecting, at at least some driving frequencies of the plurality of driving frequencies, K output current values of the power supply at each driving frequency, where K is an integer ≥1; and performing an averaging operation or a root mean square operation according to the K output current values to determine the output current.

In an embodiment, after the determining an impedance interval corresponding to the first current, the method further includes: determining, according to the impedance interval corresponding to the first current, a first impedance branch matching the impedance interval; and connecting the first impedance branch between the ultrasonic atomization sheet and a driving branch, so that a combined impedance of the first impedance branch and the ultrasonic atomization sheet matches an impedance of the driving branch, where the driving branch is a circuit for driving the ultrasonic atomization sheet.

According to a second aspect, this application provides an ultrasonic atomizer, including: a liquid storage cavity for storing a liquid substrate; an ultrasonic atomization sheet in communication with the liquid storage cavity, the ultrasonic atomization sheet being configured to generate oscillation to atomize the liquid substrate; a control circuit and a power supply, where the control circuit includes: a controller and a driving branch, where the driving branch is connected to the power supply and the controller, respectively, the driving branch is configured to generate a driving voltage in response to a first pulse signal, and the driving voltage is configured to drive the ultrasonic atomization sheet; N first switch branches and N impedance branches, where the driving branch passes through one of the first switch branches and one of the impedance branches in sequence and is then connected to the ultrasonic atomization sheet, the first switch branches are further connected to the controller, and N is an integer ≥2; and the controller is configured to output the first pulse signal, control a target first switch branch in the N first switch branches to be turned on, and control the other first switch branches to be turned off, so that a combined impedance of a first impedance branch and the ultrasonic atomization sheet matches an impedance of the driving branch, where the first impedance branch is connected to the first switch branch that is turned on.

In an embodiment, a terminal of the impedance branch is grounded, the control circuit further includes N second switch branches, one of the second switch branches is connected between one of the impedance branches and the ultrasonic atomization sheet, and the second switch branches are further connected to the controller; and the controller is further configured to control the second switch branch connected to the first impedance branch to be turned on, so that a combined impedance of the first impedance branch and the ultrasonic atomization sheet matches the impedance of the driving branch.

In an embodiment, the combined impedance of the first impedance branch and the ultrasonic atomization sheet includes a real impedance part and a virtual impedance part, and when the real impedance part is equal to the impedance of the driving branch and the virtual impedance part is less than a first preset threshold, the combined impedance of the first impedance branch and the ultrasonic atomization sheet matches the impedance of the driving branch.

In an embodiment, the control circuit further includes a current detection branch; the current detection branch is connected to the power supply, the driving branch, and the controller, respectively, and the current detection branch is configured to detect an output current of the power supply to generate a first detection signal; and the controller is further configured to: determine the output current of the power supply according to the first detection signal, determine, according to the output current and a correspondence between a preset current and a preset impedance interval, an impedance interval corresponding to the output current, and determine the first impedance branch according to the impedance interval corresponding to the output current, to control the first switch branch connected to the first impedance branch to be turned on.

In an embodiment, the current detection branch includes an amplifier and a first resistor, the first resistor is connected to the amplifier, the power supply, and the ultrasonic atomization sheet, respectively, and the amplifier is connected to the controller; and the amplifier is configured to output the first detection signal to the controller according to voltages at two ends of the first resistor, so that the controller determines the output current of the power supply according to the first detection signal.

In an embodiment, the driving branch includes: a power supply sub-branch, where the power supply sub-branch is connected to the power supply, and the power supply sub-branch is configured to generate direct-current power supply according to the power supply; a switch sub-branch, where the switch sub-branch is connected to the controller and the power supply sub-branch, respectively, and the switch sub-branch is configured to be turned on or turned off in response to the first pulse signal, to generate a pulse voltage according to the direct-current power supply; and a resonance sub-branch, where the resonance sub-branch is connected to the power supply sub-branch and the switch sub-branch, respectively, and configured to perform resonance in response to turn-on and turn-off of the switch sub-branch, to output and drive the driving voltage according to the pulse voltage.

In an embodiment, the power supply sub-branch includes a first inductor; and a first terminal of the first inductor is connected to the power supply, and a second terminal of the first inductor is connected to the switch sub-branch and the resonance sub-branch, respectively. In an embodiment, the switch sub-branch includes a switch tube; and a first terminal of the switch tube is connected to the controller, a second terminal of the switch tube is grounded, and a third terminal of the switch tube is connected to the power supply sub-branch and the resonance sub-branch, respectively.

In an embodiment, the switch sub-branch further includes a first capacitor, a first terminal of the first capacitor is connected to the third terminal of the switch tube, and a second terminal of the first capacitor is grounded; and the first capacitor is configured to be charged when the switch tube is turned off and a current flowing through the resonance sub-branch is less than a first current threshold, and is configured to perform resonance with the resonance sub-branch so as to be discharged when the switch tube is turned off and the current flowing through the resonance sub-branch is greater than or equal to the first current threshold, where the switch tube is turned on when the first capacitor is discharged to a second current threshold.

In an embodiment, the resonance sub-branch includes a second capacitor and a second inductor; and a first terminal of the second capacitor is connected to the power supply sub-branch and the switch sub-branch, respectively, a second terminal of the second capacitor is connected to a first terminal of the second inductor, and a second terminal of the second inductor is connected to the first switch branch.

In an embodiment, the first switch branch includes a first switch; and the first switch is connected between the driving branch and the impedance branch.

In an embodiment, the impedance branch includes a third inductor; and the third inductor is connected between the first switch branch and the ultrasonic atomization sheet.

In an embodiment, the impedance branch includes a fourth inductor, a third capacitor, and a fifth inductor; and a first terminal of a first terminal of the fourth inductor is connected to the first switch branch, a second terminal of the fourth inductor is connected to a first terminal of the third capacitor and a first terminal of the fifth inductor, respectively, a second terminal of the third capacitor is grounded, and a second terminal of the fifth inductor is connected to the second switch branch.

In an embodiment, the second switch branch includes a second switch; and the second switch is connected between the impedance branch and the ultrasonic atomization sheet.

The embodiments of this application have the following beneficial effects. The impedance identification method for an ultrasonic atomizer provided in this application is used for identifying an impedance of an ultrasonic atomization sheet in an ultrasonic atomizer, and the method includes: acquiring a first current, where the first current is a current output from a power supply in the ultrasonic atomizer when the ultrasonic atomization sheet operates at a resonance frequency; and determining, according to a correspondence between a preset current and a preset impedance interval, an impedance interval corresponding to the first current. Through the above method, an impedance interval within which the impedance of the ultrasonic atomization sheet falls can be determined, implementing a process of identifying the impedance of the ultrasonic atomization sheet. In addition, compared with solutions in related art, this implementation method is simpler, lower in cost, and higher in practicability.

### BRIEF DESCRIPTION OF DRAWINGS

One or more embodiments are exemplarily described with reference to corresponding accompanying drawings, and these exemplary descriptions do not constitute any limitation on the embodiments. In the accompanying drawings, elements with the same reference numerals represent similar elements, and unless otherwise particularly stated, the figures in the accompanying drawings are not drawn to scale.

FIG. 1 is a schematic structural diagram of an ultrasonic atomizer according to a first embodiment of this application;

FIG. 2 is a schematic structural diagram of an ultrasonic atomizer according to a second embodiment of this application;

FIG. 3 is a schematic structural diagram of a control circuit according to the first embodiment of this application;

FIG. 4 is a schematic structural diagram of a control circuit according to the second embodiment of this application;

FIG. 5 is a schematic structural diagram of a control circuit according to a third embodiment of this application;

FIG. 6 is a schematic diagram of a circuit structure of a current detection circuit according to the first embodiment of this application;

FIG. 7 is a schematic diagram of a circuit structure of a first switch branch and a driving branch according to the first embodiment of this application;

FIG. 8 is a schematic structural diagram of a control circuit according to a fourth embodiment of this application;

FIG. 9 is a schematic diagram of a circuit structure of a first switch branch, a second switch branch, and a driving branch according to the first embodiment of this application;

FIG. 10 is a schematic diagram of a circuit structure of a first switch branch, a second switch branch, and a driving branch according to the second embodiment of this application;

FIG. 11 is a schematic diagram of a circuit structure of a first switch branch, a second switch branch, and a driving branch according to the third embodiment of this application;

FIG. 12 is flowchart of an impedance identification method for an ultrasonic atomizer according to the first embodiment of this application;

FIG. 13 is a schematic diagram of an implementation of step 1201 shown in FIG. 12 according to the first embodiment of this application; and

FIG. 14 is a schematic diagram of a method performed after step 1202 is performed according to the first embodiment of this application.

### DETAILED DESCRIPTION

To make the objectives, technical solutions, and advantages of embodiments of this application clearer, the following clearly and completely describes the technical solutions in embodiments of this application with reference to accompanying drawings in embodiments of this application. It is clear that the described embodiments are merely some rather than all of embodiments of this application. All other embodiments obtained by a person of ordinary skill in the art based on the embodiments of this application without making creative efforts shall fall within the protection scope of this application.

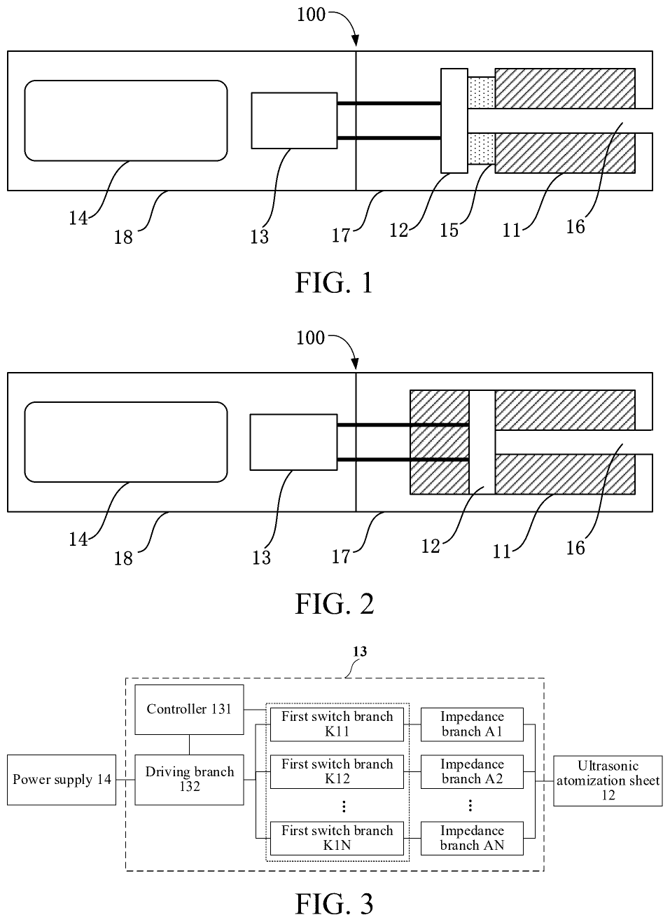

Reference is made to FIG. 1. FIG. 1 is a schematic structural diagram of an ultrasonic atomizer according to an embodiment of this application. As shown in FIG. 1, the ultrasonic atomizer 100 includes a liquid storage cavity 11, an ultrasonic atomization sheet 12, a control circuit 13, and a power supply 14.

The liquid storage cavity 11 is configured to store a liquid substrate. The liquid substrate may include different substances according to different use scenarios. For example, in the field of e-cigarette atomization, the liquid substrate may include nicotine and/or an aroma agent, and/or an aerosol generation substance (for example, glycerol). For another example, in the field of medical atomization, the liquid substrate may include solvents such as drugs for disease treatment or beneficial to health and/or physiological saline.

The ultrasonic atomization sheet 12 is in fluid communication with the liquid storage cavity 11. The ultrasonic atomization sheet 12 may be directly disposed in the liquid storage cavity 11, or an atomization cavity in which the ultrasonic atomization sheet 12 is located is in direct communication with the liquid storage cavity 11, or liquid transmission is performed between the ultrasonic atomization sheet 12 and the liquid storage cavity 11 through a liquid absorbing medium. The ultrasonic atomization sheet 12 is configured to generate oscillation to atomize the liquid substrate. That is, the liquid substrate transferred to or near the ultrasonic atomization sheet 12 is atomized into an aerosol through vibration. Specifically, during use, the ultrasonic atomization sheet 12 breaks up the liquid substrate through high-frequency vibration (preferably, a vibration frequency is in a range of 1.7 MHz to 4.0 MHz, which exceeds a human hearing range and belongs to an ultrasonic frequency band) to generate an aerosol in which particles are naturally suspended.

The control circuit 13 is electrically connected to the ultrasonic atomization sheet 12. The control circuit 13 is configured to provide a driving voltage and a driving current for the ultrasonic atomization sheet 12 according to the power supply 14. In an implementation, the control circuit 13 may be disposed on a printed circuit board (PCB).

The power supply 14 is configured to supply power. In an implementation, the power supply 14 is a battery. The battery may be a lithium-ion battery, a lithium metal battery, a lead-acid battery, a nickel-cadmium battery, a nickel-metal hydride battery, a lithium-sulfur battery, a lithium-air battery, a sodium-ion battery, or the like. This is not limited herein. In terms of scale, the battery in the embodiments of this application may be a battery cell, or may be a battery module including a plurality of battery cells connected in series and/or connected in parallel. This is not limited herein. Of course, in other embodiments, the battery may alternatively include more or fewer components, or have different component configurations. This is not limited in this embodiment of this application.

In an embodiment, the ultrasonic atomizer 100 further includes a liquid transfer medium 15 and an air outlet channel 16. The liquid transfer element 15 is configured to transfer the liquid substrate between the liquid storage cavity 11 and the ultrasonic atomization sheet 12. The air outlet channel 16 is configured to output inhalable vapor or an aerosol generated by the liquid substrate for inhalation by a user.

The ultrasonic atomizer 100 may be integrated or assembled. In an implementation, when the ultrasonic atomizer 100 is assembled, the ultrasonic atomizer 100 further includes a power supply mechanism and an ultrasonic atomizer. The ultrasonic atomizer includes a first housing 17, and the power supply mechanism includes a second housing 18.

In an embodiment, the first housing 17 is detachably connected to the second housing 18. For example, the first housing 17 may be detachably connected to the second housing 18 through a buckle structure, a magnetic structure, or the like. The first housing 17 and the second housing 18 jointly function to accommodate and protect other components. The liquid storage cavity 11, the ultrasonic atomization sheet 12, the liquid transfer element 15, and the air outlet channel 16 are all disposed in the first housing 17, and the control circuit 13 and the power supply 14 are both disposed in the second housing 18.

The first housing 17 is detachably aligned with the second housing 18 in a functional relationship. Various mechanisms may be used to connect the second housing 18 to the first housing 17, to generate a threaded engagement, a press-fit engagement, an interference fit, a magnetic engagement, or the like. In some implementations, when the first housing 17 and the second housing 18 are assembled, the ultrasonic atomizer 100 may be basically in a shape of a rod, a flat cylinder, a pole, a column, or the like.

The first housing 17 and the second housing 18 may be formed of any suitable material that is structurally sound. In some examples, the first housing 17 and the second housing 18 may be formed by a metal or an alloy such as stainless steel or aluminum. Other suitable materials including various plastics (for example, polycarbonate), metal-plating over plastic, ceramics, and the like may also be used.

It should be noted that, a hardware structure of the ultrasonic atomizer 100 shown in FIG. 1 is only an example. In addition, the ultrasonic atomizer 100 may have more or fewer components than those shown in the figure, or may combine two or more components, or may have a different component configuration. The components shown in the figure may be implemented in hardware, software, or a combination of hardware and software including one or more signal processing circuits and/or application-specific integrated circuits. For example, as shown in FIG. 2, the ultrasonic atomization sheet 12 may be disposed in the liquid storage cavity 11, thereby simplifying the structure.

In addition, it can be understood that, the ultrasonic atomizer 100 shown in FIG. 1 or FIG. 2 may be applied to a plurality of different scenarios and play different roles. This is not specifically limited in this embodiment of this application. For example, in an embodiment, the ultrasonic atomizer 100 is applied to the medical field. In this case, the ultrasonic atomizer 100 may be a medical atomizer. The medical atomizer can achieve an auxiliary treatment effect by atomizing a medical liquid added into the medical atomizer and enabling a patient to inhale. For another example, in another embodiment, the ultrasonic atomizer 100 may alternatively be used as an electronic product, for example, an e-cigarette. The e-cigarette is an electronic product that turns a nicotine solution and the like into vapor in a means such as atomization, for a user to inhale.

Reference is made to FIG. 3. FIG. 3 is a schematic structural diagram in which a control circuit 13 is connected to a power supply 14 and an ultrasonic atomization sheet 12, respectively. As shown in FIG. 3, the control circuit 13 includes a controller 131, a driving branch 132, N first switch branches, and N impedance branches.

The driving branch 132 is connected to the power supply 14 and the controller 131, respectively. The driving branch 132 passes through one first switch branch and one impedance branch in sequence and is then connected to the ultrasonic atomization sheet 12, and the N first switch branches are further connected to the controller, where N is an integer ≥2. The N first switch branches include a first switch branch K11, a first switch branch K12, . . . , and a first switch branch K1N, and the N impedance branches include an impedance branch A1, an impedance branch A2, . . . , and an impedance branch AN. The driving branch 132 is connected to the ultrasonic atomization sheet 12 through the first switch branch K11 and the impedance branch A1. The driving branch 132 is connected to the ultrasonic atomization sheet 12 through the first switch branch K12 and the impedance branch A2; . . . ; and the driving branch 132 is connected to the ultrasonic atomization sheet 12 through the first switch branch K1N and the impedance branch AN. The controller 131 is connected to the first switch branch K11, the first switch branch K12, . . . , and the first switch branch K1N, respectively.

Specifically, the controller 131 is configured to output a first pulse signal, the driving branch 132 is configured to generate a driving voltage in response to the first pulse signal, and the driving voltage is configured to drive the ultrasonic atomization sheet 12. The controller 131 is further configured to control a target first switch branch in the N first switch branches to be turned on, and control the other first switch branches to be turned off, so that a combined impedance of the first impedance branch and the ultrasonic atomization sheet 12 matches an impedance of the driving branch 132. The first impedance branch is connected to the first switch branch that is turned on.

For example, in an implementation, if the target first switch branch is the first switch branch K11, the controller 131 controls the first switch branch K11 to be turned on, and controls the first switch branch K12, the first switch branch K13, . . . , and the first switch branch K1N to be turned off. Then, a loop is formed among the driving branch 132, the first switch branch K11, the impedance branch A1, and the ultrasonic atomization sheet 12, and a combined impedance of the impedance branch A1 and the ultrasonic atomization sheet 12 matches the impedance of the driving branch 132. The impedance branch A1 is a first impedance branch.

During actual application, on one hand, the ultrasonic atomization sheet 12 may be equivalent to a capacitive load, and the driving branch 132 is a pure resistive output. If energy is directly transmitted between the two (that is, the capacitive load and the pure resistive output), relatively large reactive power will be generated, which further lead to a significant reduction in efficiency of driving the ultrasonic atomization sheet 12. Based on this, the matching between the combined impedance of the first impedance branch and the ultrasonic atomization sheet 12 and the impedance of the driving branch 132 can reduce a part of a combined reactive power of the first impedance branch and the ultrasonic atomization sheet 12, so as to reduce power loss. The ultrasonic atomization sheet 12 can obtain relatively high driving energy, thereby improving the efficiency of driving the ultrasonic atomization sheet 12, and also improving the operating efficiency of the ultrasonic atomizer 100.

On the other hand, during use of the ultrasonic atomizer 100, there is a problem that different ultrasonic atomizer has significant difference in atomization performance due to electrical characteristics of different ultrasonic atomization sheets 12. The main reasons are as follows. First, the ultrasonic atomization sheet 12 is made of piezoelectric materials, and the piezoelectric materials have significant difference in electrical characteristics, resulting in difference in electrical characteristics of different ultrasonic atomization sheets 12. Second, after the ultrasonic atomization sheet 12 is assembled, differences in assembly structure stress, pressure on the ultrasonic atomization sheet 12, contact resistance, and the like may also result in difference in electrical characteristics of the ultrasonic atomization sheet 12. Based on this, in this embodiment of this application, N impedance branches are disposed, and different parameter values are set for the N impedance branches, to satisfy matching requirements of different ultrasonic atomization sheets 12. Specifically, after an impedance branch (that is, the first impedance branch) which a current actually used ultrasonic atomization sheet 12 needs to match is determined, the current actually used ultrasonic atomization sheet 12 can match a suitable impedance branch as long as the first switch branch (that is, a target first switch branch) connected to the impedance branch is turned on. This achieves a good matching effect, helping to further reduce power loss, thereby further improving the efficiency of driving the ultrasonic atomization sheet 12.

In an implementation, a combined impedance (Zh) of the first impedance branch and the ultrasonic atomization sheet 12 includes a real impedance part (Rh) and a virtual impedance part (j*Xh). When the real impedance part is equal to an impedance (Z0) of the driving branch 132 and the virtual impedance part is less than a first preset threshold, the combined impedance of the first impedance branch and the ultrasonic atomization sheet 12 matches the impedance of the driving branch 132. Zh=Rh+j*Xh. Moreover, because the impedance of the driving branch 132 is pure resistive, Z0−R0, where R0 represents a resistance of the driving branch 132. Therefore, to satisfy that the combined impedance of the first impedance branch and the ultrasonic atomization sheet 12 matches the impedance of the driving branch 132, a condition that needs to be satisfied is: Rh=R0, and j*Xh is less than the first preset threshold. The closer j*Xh is to 0, the better the matching between the combined impedance of the first impedance branch and the ultrasonic atomization sheet 12 and the impedance of the driving branch 132, and the higher the operating efficiency of the ultrasonic atomization sheet 12.

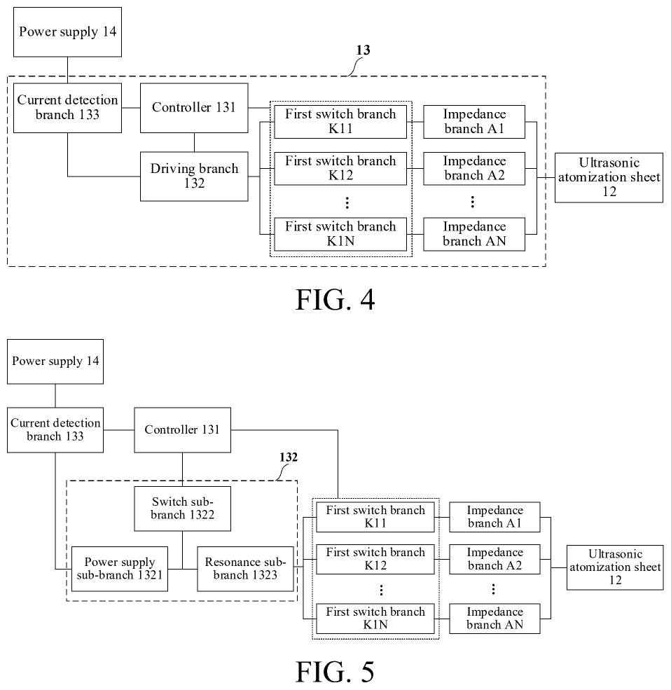

In an embodiment, as shown in FIG. 4, the control circuit 13 further includes a current detection branch 133. The current detection branch 133 is connected to the power supply 14, the driving branch 132, and the controller 131, respectively.

Specifically, the current detection branch 133 is configured to detect an output current of the power supply 14 to generate a first detection signal. The controller 131 is further configured to receive the first detection signal, and determine the output current of the power supply 14 according to the first detection signal. The controller 131 is further configured to determine, according to the output current and a correspondence between a present current and a preset impedance interval, an impedance interval corresponding to the output current, where the impedance interval is an impedance interval within which the impedance of the ultrasonic atomization sheet 12 falls, thereby achieving the purpose of identifying the impedance of the ultrasonic atomization sheet 12. The controller 131 is further configured to determine a first impedance branch according to the impedance interval corresponding to the output current, to control the first switch branch connected to the first impedance branch to be turned on.

In related art, a DDS algorithm, a phase detection circuit, and an amplitude detection circuit can be combined to accurately identify a value of the impedance of the ultrasonic atomization sheet 12. However, such method is relatively high in cost, requires complicated circuits, and is difficult to implement. Especially, in the field of ultrasonic atomizers, a sale price of the ultrasonic atomizers is relatively low. If the method in the related art is used, a net profit is excessively low, so the method is not suitable for mass production, and is poor in practicality.

However, for this application, although an actual value of the impedance of the ultrasonic atomization sheet 12 is not identified, and only the impedance interval is determined, the circuit structure used is simple, the implementation difficulty is relatively low, and thus costs can be greatly reduced, thereby facilitating mass production of the ultrasonic atomizers 100 and achieving high practicality.

Meanwhile, this application also satisfies subsequent functional design requirements. For example, in an implementation, after an impedance interval within which the impedance of the ultrasonic atomization sheet 12 falls is identified, a corresponding impedance branch can be matched according to the impedance interval, so as to reduce a capacitive or inductive part in the impedance of a first circuit formed by the ultrasonic atomization sheet 12 and the impedance branch, that is, to reduce a phase difference between a current and a voltage of the first circuit. In an embodiment, after the impedance interval within which the impedance of the ultrasonic atomization sheet 12 falls is identified and the corresponding impedance branch is matched, the phase difference between the current and the voltage of the first circuit may be maintained to be less than 30°, so that a part of a reactive power of the ultrasonic atomization sheet 12 can be reduced, helping to improve the operating efficiency of the ultrasonic atomization sheet 12.

Second, after the impedance interval within which the impedance of the ultrasonic atomization sheet 12 falls is identified, a corresponding heating control curve may be matched, that is, a corresponding power control interval may be matched, so that the liquid substrate in the ultrasonic atomizer 100 can be heated better.

In addition, after the impedance interval within which the impedance of the ultrasonic atomization sheet 12 falls is determined, an impedance branch (that is, the first impedance branch) having a relatively high matching degree with the impedance interval may be found in a plurality of preset impedance branches (including the impedance branch A1, the impedance branch A2, . . . , and the impedance branch AN). In this case, there is a relatively small phase difference between the current and the voltage of the first circuit formed by the ultrasonic atomization sheet 12 and the first impedance branch, and then the first impedance branch is connected to the circuit for use, thereby achieving a good matching effect and high efficiency of the ultrasonic atomization sheet 12.

In an embodiment, as shown in FIG. 5, the driving branch 132 includes a power supply sub-branch 1321, a switch sub-branch 1322, and a resonance sub-branch 1323. The power supply sub-branch 1321 is connected to the power supply 14 through the current detection branch 133, the switch sub-branch 1322 is connected to the controller 131 and the power supply sub-branch 1321, respectively, and the resonance sub-branch 1323 is connected to the power supply sub-branch 1321 and the switch sub-branch 1322, respectively.

Specifically, the power supply sub-branch 1321 is configured to generate direct-current power supply according to the power supply 14. The switch sub-branch 1322 is configured to be turned on or turned off in response to a first pulse signal output by the controller 131, to generate a pulse voltage according to the direct-current power supply. The resonance sub-branch 1323 is configured to perform resonance in response to turn-on and turn-off of the switch sub-branch 1322, to output and drive the driving voltage according to the pulse voltage. In this embodiment, when the ultrasonic atomization sheet 12 needs to be driven, first, the power supply 14 is converted into direct-current power supply for output after passing through the power supply sub-branch 1321. Simultaneously, the controller 131 outputs a first pulse signal, to control the switch sub-branch 1322 to constantly cyclically switch between turn-on and turn-off, so as to convert the direct-current power supply output by the power supply sub-branch 1321 into alternating-current power supply, that is, the pulse voltage. Then, after performing resonance, the resonance sub-branch 1323 can boost the received pulse voltage, and drive the ultrasonic atomization sheet 12 by using the boosted driving voltage. Because the resonance sub-branch 1323 performs resonance, the resonance sub-branch 1323 essentially presents pure impedance, so that a part of a reactive power of the resonance sub-branch 1323 can be reduced, that is, power loss is reduced, so that the operating efficiency of the ultrasonic atomizer 100 is improved. Moreover, in this case, the resonance sub-branch 1323 has a minimum impedance and a maximum current, and thus can output a relatively large driving voltage to drive the ultrasonic atomization sheet 12 to operate stably.

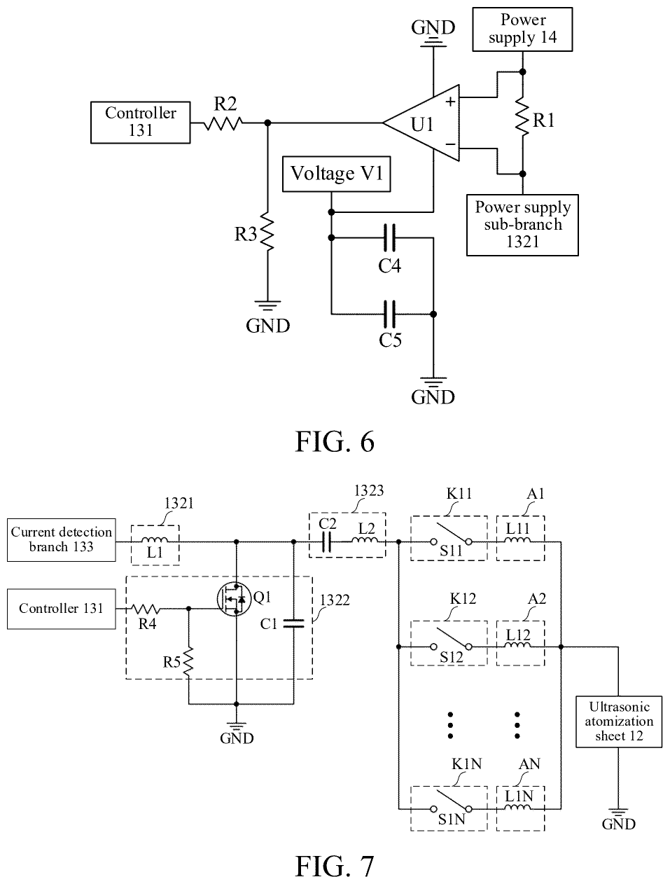

Reference is made to FIG. 6. FIG. 6 exemplarily shows a structure of the current detection branch 133. As shown in FIG. 6, the current detection branch 133 includes an amplifier U1 and a first resistor R1. The first resistor R1 is connected to the amplifier U1, the power supply 14, and the power supply sub-branch 1321, respectively, and the amplifier U1 is connected to the controller 131.

Specifically, a first terminal of the first resistor R1 is connected to the power supply 14 and a non-inverting input terminal of the amplifier U1, respectively; a second terminal of the first resistor R1 is connected to an inverting input terminal of the amplifier U1 and the power supply sub-branch 1321, respectively; an output terminal of the amplifier U1 is connected to the controller 131; a ground terminal of the amplifier U1 is grounded (GND); and a power terminal of the amplifier U1 is connected to a voltage V1.

In this embodiment, the amplifier U1 is configured to output a first detection signal according to a voltage across the first resistor R1, so that the controller 132 determines an output current of the power supply 14 according to the first detection signal. Specifically, the amplifier U1 can output the first detection signal after amplifying the received voltage across the first resistor R1 by K times, where K is a positive integer. Then, after acquiring the first detection signal, the controller 131 can determine a current output from the power supply 14 according to a relationship between the first detection signal and the current output from the power supply 14.

In an embodiment, the current detection branch 131 further includes a fourth capacitor C4, a fifth capacitor C5, a second resistor R2, and a third resistor R3. The fourth capacitor C4 and the fifth capacitor C5 are filter capacitors, the second resistor R2 is a current limiting resistor, and the third resistor R3 is a pull-down resistor.

In an embodiment, as shown in FIG. 7, the power supply sub-branch 1321 includes a first inductor L1. A first terminal of the first inductor L1 is connected to the power supply 14 through the current detection branch 133, and a second terminal of the first inductor L1 is connected to the switch sub-branch 1322 and the resonance sub-branch 1323, respectively.

Specifically, the first inductor L1 is a high-frequency choke coil. The high-frequency choke coil has a relatively significant blocking effect on only a high-frequency alternating current, has a very small blocking effect on a low-frequency alternating current, and has an even smaller blocking effect on a direct current. Therefore, the high-frequency choke coil may be used for “allowing direct current, blocking alternating current, allowing low frequency, and blocking high frequency”. Thus, the first inductor L1 may allow a direct current to pass through to provide energy for a subsequent circuit, that is, implement a process of outputting the direct-current power supply according to the power supply 14. In addition, the first inductor L1 may be further configured to prevent high-frequency short circuits.

FIG. 7 further exemplarily shows a structure of the switch sub-branch 1322. As shown in FIG. 7, the switch sub-branch 1322 includes a switch tube Q1. A first terminal of the switch tube Q1 is connected to the controller 131, a second terminal of the switch tube Q1 is grounded (GND), and a third terminal of the switch tube Q1 is connected to the power supply sub-branch 1321 and the resonance sub-branch 1323, respectively.

In this embodiment, the first switch tube Q1 being an N-type metal-oxide-semiconductor field effect transistor (that is, an NMOS transistor) is used as an example. Specifically, a gate of the NMOS transistor is the first terminal of the switch tube Q1, a source of the NMOS transistor is the second terminal of the switch tube Q1, and a drain of the NMOS transistor is the third terminal of the switch tube Q1.

Besides, in other embodiments, the switch tube Q1 may alternatively be a P-type metal-oxide-semiconductor field effect transistor or a signal relay, and the switch tube Q1 may alternatively be at least one of a triode, an insulated gate bipolar transistor, an integrated gate commutated thyristor, a gate turn-off thyristor, a junction gate field effect transistor, an MOS controlled thyristor, a gallium nitride-based power device, a silicon carbide-based power device, or a silicon-controlled rectifier.

In an embodiment, the switch sub-branch 1322 further includes a fourth resistor R4 and a fifth resistor R5 connected in series. A first terminal of a circuit formed by the fourth resistor R4 and the fifth resistor R5 connected in series is connected to the controller 131, a second terminal of the circuit formed by the fourth resistor R4 and the fifth resistor R5 connected in series is grounded (GND), and a joint between the fourth resistor R4 and the fifth resistor R5 is connected to the first terminal of the switch tube Q1.

In this embodiment, the fourth resistor R4 and the fifth resistor R5 are configured to divide a voltage of a first pulse signal output by the controller 131, to obtain a voltage at the first terminal of the switch tube Q1. When a divided voltage of the fifth resistor R5 is greater than a turn-on voltage of the switch tube Q1, the switch tube Q1 is turned on; otherwise, the switch tube Q1 is turned off.

In an embodiment, the switch sub-branch 1322 further includes a first capacitor C1, a first terminal of the first capacitor C1 is connected to the third terminal of the switch tube Q1, and a second terminal of the first capacitor C1 is grounded (GND).

Specifically, the first capacitor C1 is configured to be charged when the switch tube Q1 is turned off and a current flowing through the resonance sub-branch 1323 is less than a first current threshold, and is configured to perform resonance with the resonance sub-branch 1323 so as to be discharged when the switch tube Q1 is turned off and the current flowing through the resonance sub-branch 1323 is greater than or equal to the first current threshold. When the first capacitor C1 is discharged to a second current threshold, the switch tube Q1 is turned on. It can be understood that, setting of the first current threshold and setting of the second current threshold are both related to parameters of the first capacitor C1 and the resonance sub-branch 1323. In other words, in different application scenarios, different first current thresholds and second current thresholds may be obtained by selecting different first capacitors C1 and resonance sub-branches 1323. This is not specifically limited in this embodiment of this application.

In this embodiment, the first capacitor C1 may be set to play a role in voltage lag. Specifically, as soon as the switch tube Q1 is turned off, a voltage between the second terminal and the third terminal of the switch tube Q1 will not suddenly boost, but the voltage across the first capacitor C1 is maintained first. After a current between the second terminal and the third terminal of the switch tube Q1 decreases to zero, the voltage between the second terminal and the third terminal of the switch tube Q1 starts to boost. Thus, soft turn-off of the switch tube Q1 is implemented.

Meanwhile, when the current flowing through the resonance sub-branch 1323 is less than the first current threshold, the first capacitor C1 is charged. Subsequently, the current in the resonance sub-branch 1323 gradually increases. After being greater than or equal to the first current threshold, the current in the resonance sub-branch 1323 is greater than a current in the first inductor L1, and the first capacitor C1 performs resonance with the resonance sub-branch 1323 so as to be discharged. Then, when the first capacitor C1 is discharged to the second current threshold, the switch tube Q1 is turned on. It can be learned that, by selecting proper first capacitor C1 and resonance sub-branch 1323 to make the second current threshold be zero, zero-voltage turn-on of the switch tube Q1 can be implemented, that is, soft turn-on of the switch tube Q1 can be implemented.

It can be understood that when a transistor (for example, the switch tube Q1) is in a switching state, theoretically, 100% efficiency may be achieved. However, due to influences of a barrier capacitance and a diffusion capacitance of the transistor as well as a distributed capacitance in a circuit, the transistor requires a specified conversion time from saturation to cut-off or from cut-off to saturation. Consequently, within a conversion time, a collector current and a collector voltage of the transistor will both have relatively large values, causing an increase in transistor consumption. Usually, the influences can be ignored when a parasite capacitance is not excessively large and an operating frequency is relatively low. However, when the operating frequency is relatively high, the increase in transistor consumption cannot be ignored, which reduces the efficiency and even damages a device.

Therefore, in this embodiment, by arranging the first capacitor C1 and the resonance sub-branch 1333, a soft on-off process (including soft turn-on and soft turn-off) of the switch tube Q1 can be implemented. To be specific, when the switch tube Q1 is turned on or turned off, a product of a voltage and a current is kept to be always zero. Thus, switching loss of the switch tube Q1 is also close to zero, the switching efficiency of the switch tube Q1 is relatively high, and thus the operating efficiency of the ultrasonic atomizer 100 is also improved.

FIG. 7 further exemplarily shows a structure of the resonance sub-branch 1323. As shown in FIG. 7, the resonance sub-branch 1323 includes a second capacitor C2 and a second inductor L2. A first terminal of the second capacitor C2 is connected to the power supply sub-branch 1321 (that is, the second terminal of the first inductor L1) and the switch sub-branch 1322 (that is, the third terminal of the switch tube Q1), respectively; a second terminal of the second capacitor C2 is connected to a first terminal of the second inductor L2; and a second terminal of the second inductor L2 is connected to the first switch branch K11, the first switch branch K12, . . . , and the first switch branch K1N.

In this embodiment, when the second capacitor C2 and the second inductor L2 form a series resonance, a circuit formed by the second capacitor C2 and the second inductor L2 is purely resistive. In this case, the impedance is minimized, the current is maximized, and a high voltage that is N times greater than a pulse voltage input to the resonance sub-branch 1323 is generated in the second capacitor C2 and the second inductor L2, where N is greater than 1. The high voltage is used as a driving voltage for driving the ultrasonic atomization sheet 12. Thus, the ultrasonic atomization sheet 12 can obtain relatively sufficient driving energy, helping to maintain stable operation of ultrasonic atomization sheet 12.

In an embodiment, as shown in FIG. 7, each first switch branch includes one switch, and each switch is connected between the driving branch 132 and one impedance branch. To be specific, the first switch branch K11 includes a first switch S11, the first switch branch K12 includes a first switch S12, . . . , and the first switch branch K1N includes a first switch SIN. The first switch S11 is connected between the driving branch 132 and the impedance branch A1, the first switch S12 is connected between the driving branch 132 and the impedance branch A2, . . . , and the first switch SIN is connected between the driving branch 132 and the impedance branch AN.

In this embodiment, when the switch connected to the impedance branch is closed, the impedance branch is connected to the circuit. For example, if the impedance branch A1 is a first impedance branch matching the current ultrasonic atomization sheet 12, the first switch S11 is closed to connect the impedance branch A1 to the circuit, so that an impedance of the impedance branch A1 and the ultrasonic atomization sheet 12 matches the impedance of the driving branch 132.

In an embodiment, stilling referring to FIG. 7, any one of the impedance branches includes a third inductor. Each third inductor is connected between one first switch branch and the ultrasonic atomization sheet 12. Specifically, the impedance branch A1 includes a third inductor L11, the impedance branch A2 includes a third inductor L12, . . . , and the impedance branch AN includes a third inductor L1N. The third inductor L11 is connected between the first switch branch K11 and the ultrasonic atomization sheet 12, the third inductor L12 is connected between the first switch branch K12 and the ultrasonic atomization sheet 12, . . . , and the third inductor L1N is connected between the first switch branch K1N and the ultrasonic atomization sheet 12.

It should be noted that, FIG. 7 merely shows a structure of the impedance branch. In other embodiments, the impedance branch may alternatively be implemented by using another structure. This is not specifically limited in this embodiment of this application, as long as the combined impedance of the impedance branch and the ultrasonic atomization sheet 12 matches the combined impedance of the driving branches 133. However, it should be noted that, in the embodiments shown in FIG. 3, FIG. 4, FIG. 5, and FIG. 7, all the impedance branches should not be grounded (GND).

Further, when a terminal of the impedance branch is grounded (GND), the control circuit 13 further includes N second switch branches. One second switch branch is connected between one impedance branch and the ultrasonic atomization sheet 12.

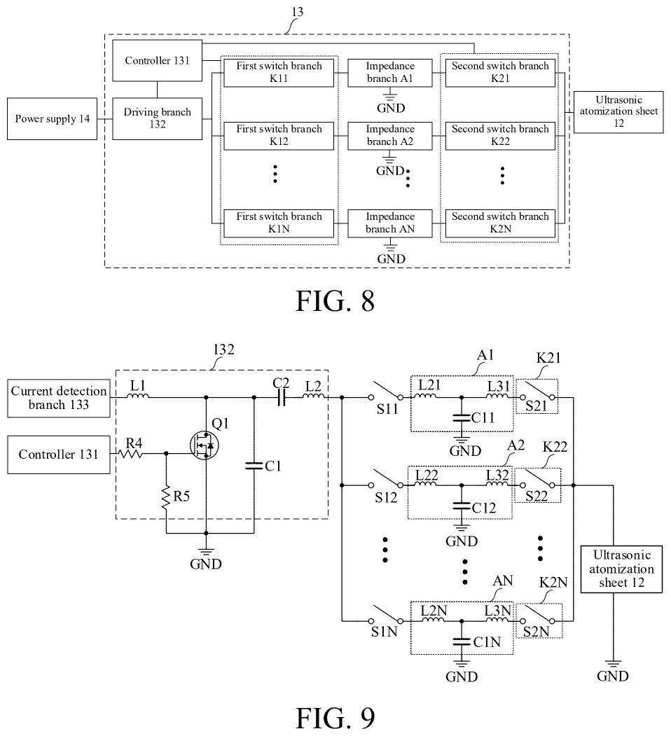

An example in which N second switch branches are added to the structure shown in FIG. 3 is used. As shown in FIG. 8, the N second switch branches include a second switch branch K21, a second switch branch K22, . . . , and a second switch branch K2N. The second switch branch K21 is connected between the impedance branch A1 and the ultrasonic atomization sheet 12, the second switch branch K22 is connected between the impedance branch A2 and the ultrasonic atomization sheet 12, . . . , and the second switch branch K2N is connected between the impedance branch AN and the ultrasonic atomization sheet 12. The second switch branch K21, the second switch branch K22, . . . , and the second switch branch K2N are all connected to the controller 131.

The controller 131 is further configured to: control the second switch branch connected to the first impedance branch to be turned on, so that the combined impedance of the first impedance branch and the ultrasonic atomization sheet 12 matches the impedance of the driving branch 132.

In this embodiment, when a terminal of the impedance branch is grounded (GND), the first switch branch and the second switch branch that are connected to the first impedance branch both need to be turned on, to connect the first impedance branch to a circuit for use, that is, to make the combined impedance of the first impedance branch and the ultrasonic atomization sheet 12 match the impedance of the driving branch 132. The provision of the N second switch branches can prevent mutual interference between the impedance branches. This helps to improve the operating stability of the ultrasonic atomizer.

In an embodiment, the first switch branches and the second switch branches each include: at least one of a relay, a triode, or a metal-oxide half-effect transistor.

Reference is made to FIG. 9. FIG. 9 exemplarily shows a structure of the second switch branch. As shown in FIG. 9, each second switch branch includes one switch, and each switch is connected between the ultrasonic atomization sheet 12 and one impedance branch. To be specific, the second switch branch K21 includes a second switch S11, the second switch branch K22 includes a second switch S22, . . . , and the second switch branch K2N includes a second switch S2N. The second switch S21 is connected between the ultrasonic atomization sheet 12 and the impedance branch A1, the second switch S22 is connected between the ultrasonic atomization sheet 12 and the impedance branch A2, . . . , and the second switch S2N is connected between the ultrasonic atomization sheet 12 and the impedance branch AN.

In this embodiment, when the switch connected to the impedance branch is closed, the impedance branch is connected to the circuit. For example, if the impedance branch A1 is a first impedance branch matching the current ultrasonic atomization sheet 12, the first switch S11 is closed to connect the impedance branch A1 to the circuit, so that an impedance of the impedance branch A1 and the ultrasonic atomization sheet 12 matches the impedance of the driving branch 132.

In an embodiment, still referring to FIG. 9, any one of the impedance branches includes a third capacitor, a fourth inductor, and a fifth inductor. A first terminal of a first terminal of the fourth inductor is connected to the first switch branch; a second terminal of the fourth inductor is connected to a first terminal of the third capacitor and a first terminal of the fifth inductor, respectively; a second terminal of the third capacitor is grounded; and a second terminal of the fifth inductor is connected to the second switch branch.

The impedance branch A1 is used as an example. The impedance branch A1 includes a third capacitor C11, a fourth inductor L21, and a fifth inductor L31. A first terminal of a first terminal of the fourth inductor L21 is connected to the first switch branch K11; a second terminal of the fourth inductor L21 is connected to a first terminal of the third capacitor C11 and a first terminal of the fifth inductor L31, respectively; a second terminal of the third capacitor C11 is grounded (GND); and a second terminal of the fifth inductor L31 is connected to the second switch branch K21.

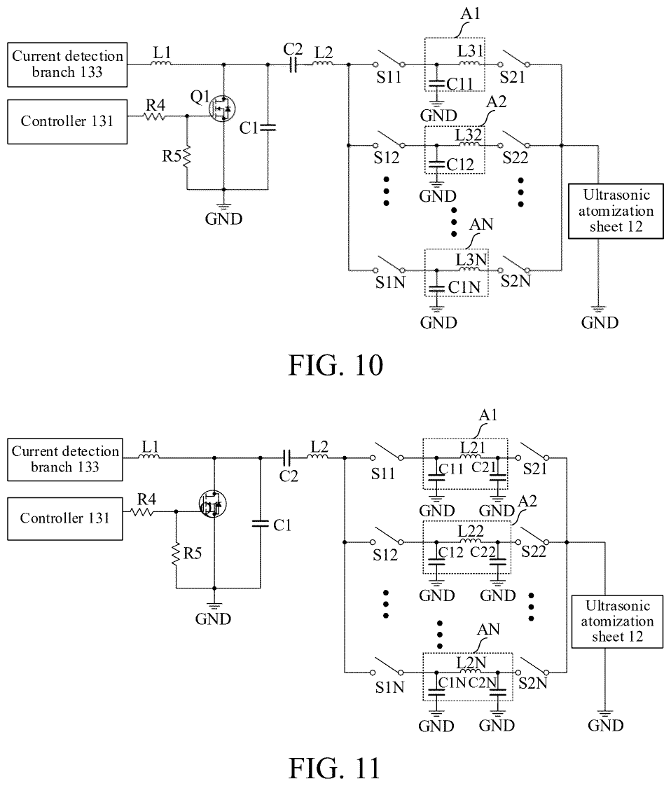

It should be noted that, FIG. 9 merely shows a structure of the impedance branch. In other embodiments, the impedance branch may alternatively be another structure. This is not specifically limited in this embodiment of this application, as long as the combined impedance of the impedance branch and the ultrasonic atomization sheet 12 matches the combined impedance of the driving branch 132. For example, in an implementation, any one of the impedance branches further includes only a third capacitor and a fifth inductor, as shown in FIG. 10. For example, the impedance branch A2 includes only a third capacitor C12 and a fifth inductor L32. For another example, in another implementation, any one of the impedance branches further includes a third capacitor, a fourth capacitor, and a fifth inductor, as shown in FIG. 11. For example, the impedance branch A1 further includes a third capacitor C11, a fourth capacitor C21, and a fifth inductor L21.

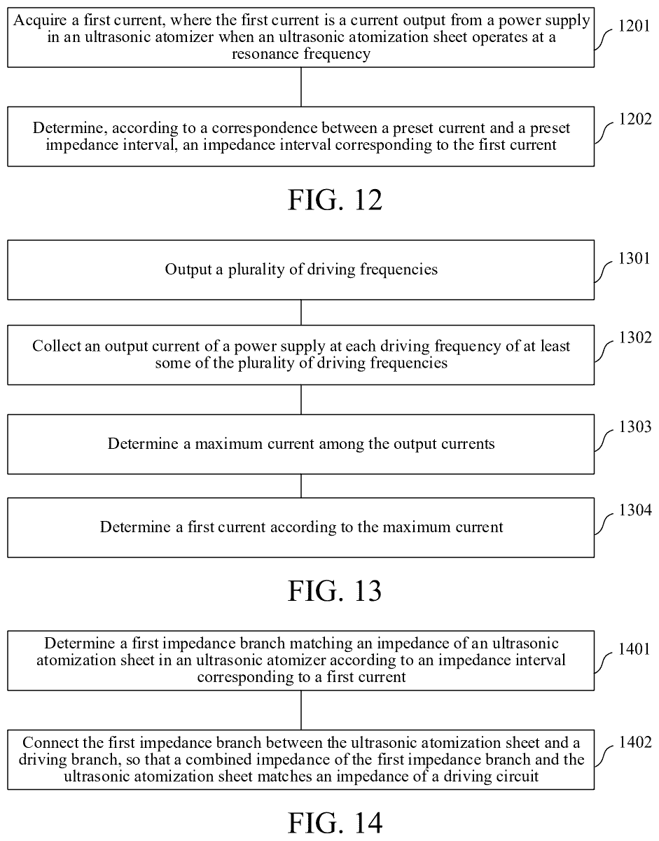

Reference is made to FIG. 12. FIG. 12 is a flowchart of an impedance identification method for an ultrasonic atomizer according to an embodiment of this application. The method is used for identifying an impedance of an ultrasonic atomization sheet in an ultrasonic atomizer. In some implementations, a specific structure of the ultrasonic atomizer may be implemented through the structures shown in FIG. 1 to FIG. 11. A specific implementation process is described in detail in the foregoing embodiments, and details are not described herein again.

As shown in FIG. 12, the impedance identification method includes the following step:

Step 1201: Acquire a first current, where the first current is a current output from a power supply in an ultrasonic atomizer when the ultrasonic atomization sheet operates at a resonance frequency.

Specifically, when the ultrasonic atomization sheet operates at a resonance frequency, the current output from the power supply (that is, the first current) is acquired, so that an impedance interval of a current ultrasonic atomization sheet is correspondingly determined according to the current. In an implementation, the first current may be acquired through the current detection branch 133 shown in FIG. 4.

In an embodiment, before step 1201 is performed, the impedance identification method further includes the following step: Control the power supply to output an initial voltage to start the ultrasonic atomization sheet to operate, where the initial voltage is any value within [5 V, 6 V].

Specifically, when different ultrasonic atomization sheets are connected to the ultrasonic atomizer for testing, the initial voltages of the ultrasonic atomization sheets during start should be kept the same, so that currents are correspondingly acquired at the same initial voltage, and thus impedance intervals of the ultrasonic atomization sheets can be correspondingly determined according to the currents. Meanwhile, the initial voltages are set to any value within [5 V, 6 V], to ensure that when the ultrasonic atomization sheets operate at a resonance frequency, the currents in the ultrasonic atomization sheets are not excessively large, so as to prevent an excessively high temperature of the ultrasonic atomization sheets.

In an implementation, as shown in FIG. 13, a process of acquiring the first current in step 1201 includes the following steps:

1301: Output a plurality of driving frequencies.

In this embodiment, an output current of the power supply is changed by outputting a plurality of driving frequencies, so that the resonance frequency of the ultrasonic atomization sheet can be determined according to the output current of the power supply.

1302: Collect an output current of the power supply at each driving frequency of at least some of the plurality of driving frequencies.

When the ultrasonic atomization sheet operates at a resonance frequency, the output current of the power supply is a maximum current, and the output current of the power supply is usually a sine wave. Therefore, as the driving frequency increases, a detected output current of the power supply tends to decrease, so there is no need to collect the currents at the subsequent driving frequencies, thereby improving the operating efficiency. To be specific, the output current of the power supply may only need to be collected at some of the plurality of driving frequencies. Alternatively, the output current of the power supply may need to be collected at all of the plurality of driving frequencies.

Specifically, in an implementation, the process of collecting an output current of the power supply at each driving frequency of at least some of the plurality of driving frequencies in step 1302 includes the following steps: Collect K output current values of the power supply at each driving frequency of at least some of the plurality of driving frequencies, where K is an integer ≥1. Perform an averaging operation or a root mean square operation according to the K output current values to determine the output current.

For example, assuming that five driving frequencies are output, and when the fourth driving frequency is output, if it is detected that the output current of the power supply decreases instead, only the output currents of the power supply at the first three driving frequencies need to be collected. First, at the first driving frequency, 5 (K=5 is used as an example) output current values are collected, the 5 output current values are summed and then averaged (that is, an averaging operation is performed) to obtain an output current, or the 5 output currents are quadratically summed, averaged, and then subjected to extraction of square root (that is, a root mean square operation is performed) to obtain an output current. In this way, the output current at the first driving frequency is determined. Then, the output current at the second driving frequency and the output current at the third driving frequency are sequentially determined in the same way.

It can be understood that, in this embodiment, K output current values being obtained and then subjected to an averaging operation or a root mean square operation to determine an output current is used as an example. However, in other embodiments, the output current may alternatively be determined in another manner. For example, a median of the K output currents is selected as the output current.

1303: Determine a maximum current among the output currents.

1304: Determine the first current according to the maximum current.

It can be learned from step 1302 that at at least some of the plurality of driving frequencies, the output current at each of the at least some driving frequencies can be determined. Then, values of the determined output currents may be compared to determine the maximum current among the output currents.

The foregoing example is still used. After three output currents, including the output current at the first driving frequency, the output current at the second driving frequency, and the output current at the third driving frequency, are determined, a maximum current among these three currents is obtained, which is taken as the first current.

Step 1202: Determine, according to the first current and a correspondence between a preset current and a preset impedance interval, an impedance interval corresponding to the first current.

In an implementation, the correspondence between the preset current and the preset impedance interval includes a correspondence between a preset current interval and the preset impedance interval, and the process of determining, according to the first current and a correspondence between a preset current and a preset impedance interval, an impedance interval corresponding to the first current in step 1202 include the following steps: Determine a current interval within which the first current falls. Determine the impedance interval corresponding to the first current interval according to the correspondence between preset current interval and the preset impedance interval.

Specifically, a current interval within which the first current falls is found according to the first current, and then an impedance interval corresponding to the current interval within which the first current falls can be determined according to the correspondence between the preset current interval and the preset impedance interval. In this way, the impedance interval corresponding to the first current is determined. The impedance interval is an impedance interval within which the impedance of the ultrasonic atomization sheet falls. In this way, the purpose of identifying the impedance of the ultrasonic atomization sheet is achieved.

In an implementation, a plurality of preset current intervals are provided, and a plurality of preset impedance intervals are provided. At least one preset impedance interval is within [5 Ω-50 Ω], and at least one preset current interval is within [0.5 A-2.2 A].

For example, in an embodiment, the preset impedance intervals are respectively [5, 10], [11, 15], [16, 20], [21, 25], [26, 30], [31, 35], [36, 40], [41, 45], and [46, 50]; and the preset current intervals are respectively [2.1, 2.2], [2, 2.1], [1.7, 1.9], [1.5, 1.6], [1.3, 1.4], [1.1, 1.2], [0.9, 1.0], [0.7, 0.8], and [0.5, 0.6]. Moreover, one impedance interval corresponds to one current interval. For example, the impedance interval [5, 10] corresponds to the current interval [2.1, 2.2]. Thus, after the first current is determined, the impedance interval corresponding to the first current can be determined according to the correspondence between the impedance interval and the current interval. In addition, in this embodiment, an example in which the preset impedance intervals are all within [5 Ω-50 Ω], and the preset current intervals are all within [0.5 A-2.2 A] is used. However, in other embodiments, another setting manner may alternatively be used. This is not specifically limited in this embodiment of this application.

The impedance interval corresponding to the first current is an impedance interval within which the impedance of the ultrasonic atomization sheet 12 falls. After the impedance interval within which the impedance of the ultrasonic atomization sheet 12 falls is determined, a corresponding impedance branch can be matched to the current ultrasonic atomization sheet 12, and this impedance branch is the first impedance branch.

In an implementation, the first impedance branch includes at least one of an L-type matching branch, a T-type matching branch, and a π-type matching branch.

In an embodiment, as shown in FIG. 14, after step 1202 is performed, the impedance identification method further includes the following steps:

Step 1401: Determine, according to the impedance interval corresponding to the first current, a first impedance branch matching the impedance of the ultrasonic atomization sheet in the ultrasonic atomizer.

Step 1402: Connect the first impedance branch between the ultrasonic atomization sheet and the driving branch, so that a combined impedance of the first impedance branch and the ultrasonic atomization sheet matches an impedance of a driving circuit.

The driving branch is a circuit for driving the ultrasonic atomization sheet 12. For details, reference may be made to the driving branch 132 shown in FIG. 3 or FIG. 4.

A circuit structure shown in FIG. 8 is used as an example. If the first impedance branch is the impedance branch AN, the first switch branch K1N and the second switch branch K2N are turned on, so that the impedance branch can be connected between the driving branch 132 and the ultrasonic atomization sheet 12, and thus a combined impedance of the impedance branch AN and the ultrasonic atomization sheet 12 can match the driving circuit 132, and a part of a combined reactive power of the impedance branch AN and the ultrasonic atomization sheet 12 can be reduced, thereby reducing power loss. The ultrasonic atomization sheet 12 can obtain relatively high driving energy, thereby improving the efficiency of driving the ultrasonic atomization sheet 12, and also improving the operating efficiency of the ultrasonic atomizer 100.

It should be understood that, for specific control and beneficial effects of the ultrasonic atomizer in the method embodiments, reference may be made to the corresponding descriptions in the foregoing embodiments of the ultrasonic atomizer. For brevity, details are not described herein again.

Finally, it should be noted that: the foregoing embodiments are merely used for describing the technical solutions of this application rather than for limiting this application. Under the ideas of this application, the technical features in the foregoing embodiments or different embodiments may alternatively be combined, the steps may be performed in any order, and many other changes of different aspects of this application also exist as described above, and these changes are not provided in detail for simplicity. Although this application is described in detail with reference to the foregoing embodiments, it should be appreciated by a person of ordinary skill in the art that: modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of this application.

1. An impedance identification method for an ultrasonic atomizer, wherein the impedance identification method is used for identifying an impedance of an ultrasonic atomization sheet in the ultrasonic atomizer and comprises:
acquiring a first current, wherein the first current is a current output from a power supply in the ultrasonic atomizer when the ultrasonic atomization sheet operates at a resonance frequency; and
determining, according to the first current and a correspondence between a preset current and a preset impedance interval, an impedance interval corresponding to the first current.

2. The impedance identification method according to claim 1, wherein the correspondence between the preset current and the preset impedance interval comprises a correspondence between a preset current interval and a preset impedance interval; and
the determining, according to the first current and a correspondence between a preset current and a preset impedance interval, an impedance interval corresponding to the first current comprises:
determining a current interval within which the first current falls; and
determining the impedance interval corresponding to the first current interval according to a correspondence between a preset current interval and a preset impedance interval.

3. The impedance identification method according to claim 2, wherein a plurality of preset current intervals are provided, and a plurality of preset impedance intervals are provided,
at least one preset impedance interval is within [5 Ω-50 Ω], and at least one preset current interval is within [0.5 A-2.2 A].

4. The impedance identification method according to claim 1, wherein before the acquiring a first current, the method further comprises:
controlling the power supply to output an initial voltage to start the ultrasonic atomization sheet to operate, wherein the initial voltage is any value within [5 V, 6 V].

5. The impedance identification method according to claim 1, wherein the acquiring a first current comprises:
outputting a plurality of driving frequencies;
collecting, at at least some of the plurality of driving frequencies, an output current of the power supply at each driving frequency;
determining a maximum current among the output currents; and
determining the first current according to the maximum current.

6. The impedance identification method according to claim 5, wherein the collecting, at at least some of the plurality driving frequencies, an output current of the power supply at each driving frequency comprises:
collecting, at at least some driving frequencies of the plurality of driving frequencies, K output current values of the power supply at each driving frequency, wherein K is an integer ≥1; and
performing an averaging operation or a root mean square operation according to the K output current values to determine the output current.

7. The method according to claim 1, wherein after the determining an impedance interval corresponding to the first current, the method further comprises:
determining, according to the impedance interval corresponding to the first current, a first impedance branch matching the impedance interval; and
connecting the first impedance branch between the ultrasonic atomization sheet and a driving branch, so that a combined impedance of the first impedance branch and the ultrasonic atomization sheet matches an impedance of the driving branch, wherein the driving branch is a circuit for driving the ultrasonic atomization sheet.

8. An ultrasonic atomizer, comprising:
a liquid storage cavity for storing a liquid substrate;
an ultrasonic atomization sheet in communication with the liquid storage cavity, the ultrasonic atomization sheet being configured to generate oscillation to atomize the liquid substrate;
a control circuit and a power supply,
wherein the control circuit comprises:
a controller and a driving branch, wherein the driving branch is connected to the power supply and the controller, respectively, the driving branch is configured to generate a driving voltage in response to a first pulse signal, and the driving voltage is configured to drive the ultrasonic atomization sheet;
N first switch branches and N impedance branches, wherein the driving branch passes through one of the first switch branches and one of the impedance branches in sequence and is then connected to the ultrasonic atomization sheet, the first switch branches are further connected to the controller, and N is an integer ≥2; and
the controller is configured to output the first pulse signal, control a target first switch branch in the N first switch branches to be turned on, and control the other first switch branches to be turned off, so that a combined impedance of a first impedance branch and the ultrasonic atomization sheet matches an impedance of the driving branch, wherein the first impedance branch is connected to the first switch branch that is turned on.

9. The ultrasonic atomizer according to claim 8, wherein a terminal of the impedance branch is grounded, the control circuit further comprises N second switch branches, one of the second switch branches is connected between one of the impedance branches and the ultrasonic atomization sheet, and the second switch branches are further connected to the controller; and
the controller is further configured to control the second switch branch connected to the first impedance branch to be turned on, so that a combined impedance of the first impedance branch and the ultrasonic atomization sheet matches the impedance of the driving branch.

10. The ultrasonic atomizer according to claim 8, wherein the combined impedance of the first impedance branch and the ultrasonic atomization sheet comprises a real impedance part and a virtual impedance part, and when the real impedance part is equal to the impedance of the driving branch and the virtual impedance part is less than a first preset threshold, the combined impedance of the first impedance branch and the ultrasonic atomization sheet matches the impedance of the driving branch.

11. The ultrasonic atomizer according to claim 8, wherein the control circuit further comprises a current detection branch;
the current detection branch is connected to the power supply, the driving branch, and the controller, respectively, and the current detection branch is configured to detect an output current of the power supply to generate a first detection signal; and
the controller is further configured to: determine the output current of the power supply according to the first detection signal, determine, according to the output current and a correspondence between a preset current and a preset impedance interval, an impedance interval corresponding to the output current, and determine the first impedance branch according to the impedance interval corresponding to the output current, to control the first switch branch connected to the first impedance branch to be turned on.

12. (canceled)

13. The ultrasonic atomizer according to claim 8, wherein the driving branch comprises:
a power supply sub-branch, wherein the power supply sub-branch is connected to the power supply, and the power supply sub-branch is configured to generate direct-current power supply according to the power supply;
a switch sub-branch, wherein the switch sub-branch is connected to the controller and the power supply sub-branch, respectively, and the switch sub-branch is configured to be turned on or turned off in response to the first pulse signal, to generate a pulse voltage according to the direct-current power supply; and
a resonance sub-branch, wherein the resonance sub-branch is connected to the power supply sub-branch and the switch sub-branch, respectively, and configured to perform resonance in response to turn-on and turn-off of the switch sub-branch, to output and drive the driving voltage according to the pulse voltage.

14. The ultrasonic atomizer according to claim 13, wherein the power supply sub-branch comprises a first inductor; and
a first terminal of the first inductor is connected to the power supply, and a second terminal of the first inductor is connected to the switch sub-branch and the resonance sub-branch, respectively.

15. The ultrasonic atomizer according to claim 13, wherein the switch sub-branch comprises a switch tube; and
a first terminal of the switch tube is connected to the controller, a second terminal of the switch tube is grounded, and a third terminal of the switch tube is connected to the power supply sub-branch and the resonance sub-branch, respectively.

16. The ultrasonic atomizer according to claim 15, wherein the switch sub-branch further comprises a first capacitor, a first terminal of the first capacitor is connected to the third terminal of the switch tube, and a second terminal of the first capacitor is grounded; and
the first capacitor is configured to be charged when the switch tube is turned off and a current flowing through the resonance sub-branch is less than a first current threshold, and is configured to perform resonance with the resonance sub-branch so as to be discharged when the switch tube is turned off and the current flowing through the resonance sub-branch is greater than or equal to the first current threshold,
wherein the switch tube is turned on when the first capacitor is discharged to a second current threshold.

17. The ultrasonic atomizer according to claim 13, wherein the resonance sub-branch comprises a second capacitor and a second inductor; and
a first terminal of the second capacitor is connected to the power supply sub-branch and the switch sub-branch, respectively, a second terminal of the second capacitor is connected to a first terminal of the second inductor, and a second terminal of the second inductor is connected to the first switch branch.

18. The ultrasonic atomizer according to claim 8, wherein the first switch branch comprises a first switch; and
the first switch is connected between the driving branch and the impedance branch.

19. The ultrasonic atomizer according to claim 8, wherein the impedance branch comprises a third inductor; and
the third inductor is connected between the first switch branch and the ultrasonic atomization sheet.

20. The ultrasonic atomizer according to claim 9, wherein the impedance branch comprises a fourth inductor, a third capacitor, and a fifth inductor; and
a first terminal of a first terminal of the fourth inductor is connected to the first switch branch, a second terminal of the fourth inductor is connected to a first terminal of the third capacitor and a first terminal of the fifth inductor, respectively, a second terminal of the third capacitor is grounded, and a second terminal of the fifth inductor is connected to the second switch branch.

21. The ultrasonic atomizer according to claim 9, wherein the second switch branch comprises a second switch; and
the second switch is connected between the impedance branch and the ultrasonic atomization sheet.
